(19) United States
(12) Patent Application Publication
(10) Pub. No.: US 2018/0005378 A1
(43) Pub. Date: Jan. 4, 2018

(54) Atlas-Based Determination of Tumor Growth Direction

(71) Applicant: Brainlab AG, Munich (DE)

(72) Inventors: Balint VARKUTI, Munich (DE); Valentin ELEFTERIU, Kirchheim (DE)

(21) Appl. No.: 15/540,505

(22) PCT Filed: Jan. 19, 2016
(86) PCT No.: PCT/EP2016/051022

§ 371 Date: Jun. 28, 2017

(30) Foreign Application Priority Data
Jan. 20, 2015 (EP) PCT/EP2015/050981

(51) Int. Cl. G06T 7/00; G06T 7/254

(52) U.S. Cl. CPC G06T 7/0016; G06T 7/254; G06T 2207/20221; G06T 2207/10072; G06T 2207/30096; G06T 2207/20128

(57) ABSTRACT

The invention relates to a method for determining the spatial development of tumor tissue, by acquiring patient medical image data describing sequences of patient medical images of tumors in parts of patient bodies, wherein the patient medical images of each sequence have been taken at subsequent points in time and each sequence has been taken tier a different patient; determining, by additively fusing subsequent patient medical images of each sequence to one another, patient spatial development data describing the spatial development of a tumor in each patient body; acquiring atlas data describing an atlas representation of the parts of patient bodies; determining, based on the atlas data and the patient development data, development probability data describing a probability for a spatial development of a tumor.

The present invention is directed to a medical data processing method for determining the spatial development of tumour tissue, a computer running that program and a system comprising that computer.

When planning a medical procedure such as surgical tumour therapy, it is desirable to determine information about the probable direction of growth of the tumour over time so as to be able to determine e.g. how much tissue to resect at certain positions in the tumour cavity. Current approaches provide merely for anecdotal or experience-based information of individual physicians how a certain type of tumour might develop spatially. Relying on such information, however, is associated with a large uncertainty as to the pathologic effect of leaving tumour tissue at certain positions in the resection cavity.

An object of the invention therefore is to provide an improved method of determining the probable growth direction of tumour tissue.

Aspects of the present invention and their embodiments are disclosed in the following. Different advantageous features can be combined in accordance with the invention wherever technically expedient and feasible.

The present invention is designed to be used for example with the Intraoperative Structure Application supplied by Brainlab AG. In this context, the integration of the invention would allow the user to update a drawn tumour segmentation object in an image on the basis of progress during the surgical resection procedure. While doing so visualizations of the probable tumour growth direction overlaid on the tumour segmentation object could provide guidance as to which areas to resect with greater care.

### EXEMPLARY SHORT DESCRIPTION OF THE PRESENT INVENTION

In the following, a short description of the specific features of the present invention is given which shall not be understood to limit the invention only to the features or a combination of the features described in this section.

The present invention relates for example to a method for determining the probable main growth direction of a tumour which is determined based on comparing predetermined sequences of CT or MR (probably contrast-agent enhanced) scans of different patients which offer information about probable tumour growth directions to an atlas describing a statistical distribution of tissue types in a plurality of patient types.

### GENERAL DESCRIPTION OF THE PRESENT INVENTION

In this section, a description of the general features of the present invention is given for example by referring to possible embodiments of the invention.

In one aspect, the invention is directed to a medical data processing method for determining the spatial development of tumour tissue, the method comprising the following steps which are constituted to be executed (for example, are executed) by a computer (for example, each one of the steps of the disclosed method is executed by a processing unit of an electronic data processing device which may be specifically configured to execute the respective step or steps).

For example, patient medical image data is acquired which describes sequences (i.e. a plurality of sequences) of patient medical images of tumours in parts (for example anatomical body parts) of patient bodies, wherein the patient medical images of each sequence have been taken at subsequent points in time and each sequence has been taken for a different patient. In other words, each sequence comprises patient medical images of an individual patient which have been taken at different points in time. More specifically, the patient medical images are sorted in each sequence in order of the time at which they were generated, for example in order of ascending time.

For example, determining patient spatial development data describing the spatial development (for example, growth and/or movement) of a tumour in each patient body is determined. This is in one embodiment done based on (specifically, by) additively fusing subsequent patient medical images of each sequence to one another. The fusing is performed for example by applying an elastic or a rigid fusion algorithm to the patient medical images. The additive fusing comprises fusing, at the beginning, the patient medical image taken at the first point in time in the respective sequence to the subsequent patient medical image of that sequence, and then fusing the subsequent patient medical image to its closest neighbouring (in a time-wise sense) patient medical image. Finally, the results of the two fusions are added to one another and for each subsequent pair of neighbouring images, this way of calculating the additive fusion is continued by adding up the results of subsequent (specifically, image pair-wise) fusions until the fusion between the second-to-last image in the sequence and the last image in the sequence has been determined and added to the additive results of the preceding fusions. The additive fusion can be exemplified by the following algebra:

Fusion_add=Fusion(image1,image2)+Fusion(image2,image3)+ . . . +Fusion(image[N−1],image[N])=sum(Fusion(image[i],image[i+1])) for i=1, . . . , N−1
where: Fusion_add is the additive fusion function;
Fusion(image[i−1], image[i]) is the pair-wise fusion function applied to the [i−1]-th patient medical image and i-th patient medical image of a sequence of patient medical images;
N is the total number of patient medical images contained in the sequence; and
sum(.) is the sum function.

For example, atlas data is acquired which describes an atlas representation of the parts of patient bodies. Specifically, the atlas representation is a universal atlas which incorporates atlas information about a plurality of types of patients which conform to the types of patients from which the patient medical image data was determined.

For example, development probability data describing a probability for a spatial development of a tumour is determined based on (specifically, from) the atlas data and the patient development data. This is in one embodiment done for example based on (specifically, by) transforming the patient spatial development data into an atlas reference system in which spatial relationships in the atlas representation are defined. Then, the atlas data is for example is fused to the patient spatial development data in order to for example establish a spatial relationship (a mapping) between specific anatomical structures and the atlas information (for example, on the basis of comparing tissue types determined from the respective image data by analysing grey values). According to an embodiment, transforming the patient spatial development data into the atlas reference system includes fusing, to the atlas data, the result of additively fusing the patient medical images of each sequence. According to a further embodiment, the position of the tumour in the first patient medical image of each sequence is used as a starting condition for determining the development probability data.

In one specific embodiment of the disclosed method, determining the development probability data includes determining a growth cone of the tumour for each starting condition. The growth cone describes a probability of spatial development (for example, growth or decrease) of the tumour relative to a specific main development direction and can be visualized for example as a cone-shaped geometry having a specific opening angle which is related to the probability of a spatial development in a direction running through the origin of the cone and a specific position on the base surface of the cone. That probability is related specifically to the angle between that direction and the cone main axis. The term “growth cone” does not limit the growth cone to a spatial development resembling growth, rather it may also encompass a scenario in which the spatial development resembles a decrease in size of the tumour.

A growth vector (G) representing the main development direction can be derived from the time-series (1, 2, . . . , t) of images (I) (i.e. the sequence of patient medical images I1, I2, . . . , It) by executing the following steps a) to g):

a) segmenting an object (T) representing the tumour in each image included in the sequence;

b) determining the centre of mass of the tumour object (cT) for each image;

c) performing a registration of each image to a common reference system/atlas space (i.e. the atlas reference system) and transposing the images using said registrations (e.g. 3D warps/vectors fields);

d) calculating vectors from the centre of mass (cT) of the first tumour object (T in I1) to the centre of mass of the tumour object in the next image of the sequence (cT in I2) and repeating this procedure until all overlaid tumours are connected by such vectors (until cT in It)—the vectors are also called growth vectors;

e) averaging all growth vectors to determine one main development direction from the tumour object in the first image to the tumour object in the last image, and for example storing that vector;

f) after repeating above steps a to e for the sequences of patient medical images described by the patient medical image data, superimposing all growth vectors for the sequences of patient medical images, wherein the sequences constitute for example co-located tumour time series which are in the common reference system;

g) deriving, from the superposition of growth vectors, a growth cone resembling a main growth vector across for tumours which are co-located between corresponding images of different sequences (i.e. images belonging to different sequences which have the same position in the sequence to which they belong).

Co-location is determined by a rule set, such as e.g. 80% of the tumour has to be in union or intersect all other tumours in that region. These growth vectors/growth cones can be used for direction prediction, the valid growth direction is identified if the new (for example, not part of the training set) tumour is co-located to the available set, if the tumour is outside of the zones for which growth data exists, no prediction for the main development direction can be given.

In another embodiment, above steps a, b, d, and e are performed on patient medical images from one (i.e. a single) sequence that have been brought into overlay by a chain fusion (i.e. the above-described additive fusion), and above step c is executed prior to above step f, thereby only transposing the growth vector from the individual time series (sequence) into a common reference system/atlas space instead of all individual images available. Step g is still executed in common reference system/atlas space.

In an even further embodiment, the disclosed method comprises the following steps:
acquiring patient-specific medical image data describing a tumour in a patient to be treated; and
determining, based on the patient-specific medical image data and the development probability data, patient-specific development probability data describing a probability for a spatial development of the tumour in the patient to be treated.

The patient-specific development probability data is in one embodiment determined by registering the patient-specific medical image data with the development probability data. The patient-specific medical image data and the patient-specific development probability data may in a further embodiment serve as a basis for determining patient-specific probability indication data describing an indication signal to be output to a user using the information content of the patient-specific development probability data. The indication signal may be a visual signal output by an indication output unit (for example, a display device operatively coupled to a computer executing a program comprising the steps of the disclosed method). Thus, the disclosed method may comprise a step of outputting, to a user and using an indication device for indicating digital information, the indication signal. The indication device may include a graphical output device and wherein the indication to be output includes a visualization of the information content of the patient-specific probability indication data.

Where this disclosures mentions image data, such image data is generated for example by application of a medical imaging modality to the structure to be imaged, for example a computed x-ray tomography or a magnetic resonance tomography modality. The patient medical image data may hence have been taken by application of a computed x-ray tomography imaging method or a magnetic resonance imaging method to the patients' bodies, or by imaging of radiation emitted from a substance emitting ionizing radiation, in particular a radioactive substance, introduced into the patients' bodies.

In another aspect, the invention also relates to a program which, when running on a computer, causes the computer to perform one or more or all of the method steps described herein. In a further aspect, the invention relates to a program storage medium on which the program is stored (for example in a non-transitory form) and/or to a computer comprising said program storage medium. The computer is for example an electronic data processing unit which is specifically configured to execute the aforementioned program, for example the electronic data processing unit of a medical navigation system or a medical procedure planning system (suitable for us e.g. in surgery or radiotherapy/radiosurgery). In an even further aspect, the invention relates to a (physical, for example electrical, for example technically generated) signal wave, for example a digital signal wave, carrying information which represents the aforementioned program, which comprises code means which are adapted to perform any or all of the method steps described herein.

It is within the scope of the present invention to combine one or more features of one or more embodiments or aspects of the invention in order to form a new embodiment wherever this is technically expedient and/or feasible. Specifically, a feature of one embodiment which has the same or a similar function to another feature of another embodiment can be exchanged with said other feature, and a feature of one embodiment which adds an additional function to another embodiment can for example be added to said other embodiment.

### DEFINITIONS

In this section, definitions for specific terminology used in this disclosure are offered which also form part of the present disclosure.

Within the framework of the invention, computer program elements can be embodied by hardware and/or software (this includes firmware, resident software, micro-code, etc.). Within the framework of the invention, computer program elements can take the form of a computer program product which can be embodied by a computer-usable, for example computer-readable data storage medium comprising computer-usable, for example computer-readable program instructions, “code” or a “computer program” embodied in said data storage medium for use on or in connection with the instruction-executing system. Such a system can be a computer; a computer can be a data processing device comprising means for executing the computer program elements and/or the program in accordance with the invention, for example a data processing device comprising a digital processor (central processing unit or CPU) which executes the computer program elements, and optionally a volatile memory (for example a random access memory or RAM) for storing data used for and/or produced by executing the computer program elements. Within the framework of the present invention, a computer-usable, for example computer-readable data storage medium can be any data storage medium which can include, store, communicate, propagate or transport the program for use on or in connection with the instruction-executing system, apparatus or device. The computer-usable, for example computer-readable data storage medium can for example be, but is not limited to, an electronic, magnetic, optical, electromagnetic, infrared or semiconductor system, apparatus or device or a medium of propagation such as for example the Internet. The computer-usable or computer-readable data storage medium could even for example be paper or another suitable medium onto which the program is printed, since the program could be electronically captured, for example by optically scanning the paper or other suitable medium, and then compiled, interpreted or otherwise processed in a suitable manner. The data storage medium is preferably a non-volatile data storage medium. The computer program product and any software and/or hardware described here form the various means for performing the functions of the invention in the example embodiments. The computer and/or data processing device can for example include a guidance information device which includes means for outputting guidance information. The guidance information can be outputted, for example to a user, visually by a visual indicating means (for example, a monitor and/or a lamp) and/or acoustically by an acoustic indicating means (for example, a loudspeaker and/or a digital speech output device) and/or tactilely by a tactile indicating means (for example, a vibrating element or a vibration element incorporated into an instrument). For the purpose of this document, a computer is a technical computer which for example comprises technical, for example tangible components, for example mechanical and/or electronic components. Any device mentioned as such in this document is a technical and for example tangible device.

The method in accordance with the invention is for example a data processing method. The data processing method is preferably performed using technical means, for example a computer. The data processing method is preferably constituted to be executed by or on a computer and for example is executed by or on the computer. For example, all the steps or merely some of the steps (i.e. less than the total number of steps) of the method in accordance with the invention can be executed by a computer. The computer for example comprises a processor and a memory in order to process the data, for example electronically and/or optically. The calculating steps described are for example performed by a computer. Determining steps or calculating steps are for example steps of determining data within the framework of the technical data processing method, for example within the framework of a program. A computer is for example any kind of data processing device, for example electronic data processing device. A computer can be a device which is generally thought of as such, for example desktop PCs, notebooks, netbooks, etc., but can also be any programmable apparatus, such as for example a mobile phone or an embedded processor. A computer can for example comprise a system (network) of “sub-computers”, wherein each sub-computer represents a computer in its own right. The term “computer” includes a cloud computer, for example a cloud server. The term “cloud computer” includes a cloud computer system which for example comprises a system of at least one cloud computer and for example a plurality of operatively interconnected cloud computers such as a server farm. Such a cloud computer is preferably connected to a wide area network such as the world wide web (WWW) and located in a so-called cloud of computers which are all connected to the world wide web. Such an infrastructure is used for “cloud computing”, which describes computation, software, data access and storage services which do not require the end user to know the physical location and/or configuration of the computer delivering a specific service. For example, the term “cloud” is used in this respect as a metaphor for the Internet (world wide web). For example, the cloud provides computing infrastructure as a service (IaaS). The cloud computer can function as a virtual host for an operating system and/or data processing application which is used to execute the method of the invention. The cloud computer is for example an elastic compute cloud (EC2) as provided by Amazon Web Services™. A computer for example comprises interfaces in order to receive or output data and/or perform an analogue-to-digital conversion. The data are for example data which represent physical properties and/or which are generated from technical signals. The technical signals are for example generated by means of (technical) detection devices (such as for example devices for detecting marker devices) and/or (technical) analytical devices (such as for example devices for performing imaging methods), wherein the technical signals are for example electrical or optical signals. The technical signals for example represent the data received or outputted by the computer. The computer is preferably operatively coupled to a display device which allows information outputted by the computer to be displayed, for example to a user. One example of a display device is an augmented reality device (also referred to as augmented reality glasses) which can be used as “goggles” for navigating. A specific example of such augmented reality glasses is Google Glass (a trademark of Google, Inc.). An augmented reality device can be used both to input information into the computer by user interaction and to display information outputted by the computer. Another example of a display device would be a standard computer monitor comprising for example a liquid crystal display operatively coupled to the computer for receiving display control data from the computer for generating signals used to display image information content on the display device. A specific embodiment of such a computer monitor is a digital lightbox. The monitor may also be the monitor of a portable, for example handheld, device such as a smart phone or personal digital assistant or digital media player.

The expression “acquiring data” for example encompasses (within the framework of a data processing method) the scenario in which the data are determined by the data processing method or program. Determining data for example encompasses measuring physical quantities and transforming the measured values into data, for example digital data, and/or computing the data by means of a computer and for example within the framework of the method in accordance with the invention. The meaning of “acquiring data” also for example encompasses the scenario in which the data are received or retrieved by the data processing method or program, for example from another program, a previous method step or a data storage medium, for example for further processing by the data processing method or program. The expression “acquiring data” can therefore also for example mean waiting to receive data and/or receiving the data. The received data can for example be inputted via an interface. The expression “acquiring data” can also mean that the data processing method or program performs steps in order to (actively) receive or retrieve the data from a data source, for instance a data storage medium (such as for example a ROM, RAM, database, hard drive, etc.), or via the interface (for instance, from another computer or a network). The data can be made “ready for use” by performing an additional step before the acquiring step. In accordance with this additional step, the data are generated in order to be acquired. The data are for example detected or captured (for example by an analytical device). Alternatively or additionally, the data are inputted in accordance with the additional step, for instance via interfaces. The data generated can for example be inputted (for instance into the computer). In accordance with the additional step (which precedes the acquiring step), the data can also be provided by performing the additional step of storing the data in a data storage medium (such as for example a ROM, RAM, CD and/or hard drive), such that they are ready for use within the framework of the method or program in accordance with the invention. The step of “acquiring data” can therefore also involve commanding a device to obtain and/or provide the data to be acquired. For example, the acquiring step does not involve an invasive step which would represent a substantial physical interference with the body, requiring professional medical expertise to be carried out and entailing a substantial health risk even when carried out with the required professional care and expertise. For example, the step of acquiring data, for example determining data, does not involve a surgical step and for example does not involve a step of treating a human or animal body using surgery or therapy. In order to distinguish the different data used by the present method, the data are denoted (i.e. referred to) as “XY data” and the like and are defined in terms of the information which they describe, which is then preferably referred to as “XY information” and the like.

Atlas data describes (for example defines and/or represents and/or is) for example a general three-dimensional shape of the anatomical body part. The atlas data therefore represents an atlas of the anatomical body part. An atlas typically consists of a plurality of generic models of objects, wherein the generic models of the objects together form a complex structure. For example, the atlas constitutes a statistical model of a patient's body (for example, a part of the body) which has been generated from anatomic information gathered from a plurality of human bodies, for example from medical image data containing images of such human bodies. In principle, the atlas data therefore represents the result of a statistical analysis of such medical image data for a plurality of human bodies. This result can be output as an image—the atlas data therefore contains or is comparable to medical image data. Such a comparison can be carried out for example by applying an image fusion algorithm which conducts an image fusion between the atlas data and the medical image data. The result of the comparison can be a measure of similarity between the atlas data and the medical image data. The human bodies, the anatomy of which serves as an input for generating the atlas data, advantageously share a common feature such as at least one of gender, age, ethnicity, body measurements (e.g. size and/or mass) and pathologic state. The anatomic information describes for example the anatomy of the human bodies and is extracted for example from medical image information about the human bodies. The atlas of a femur, for example, can comprise the head, the neck, the body, the greater trochanter, the lesser trochanter and the lower extremity as objects which together make up the complete structure. The atlas of a brain, for example, can comprise the telencephalon, the cerebellum, the diencephalon, the pons, the mesencephalon and the medulla as the objects which together make up the complex structure. One application of such an atlas is in the segmentation of medical images, in which the atlas is matched to medical image data, and the image data are compared with the matched atlas in order to assign a point (a pixel or voxel) of the image data to an object of the matched atlas, thereby segmenting the image data into objects.

Image fusion can be elastic image fusion or rigid image fusion. In the case of rigid image fusion, the relative position between the pixels of a 2D image and/or voxels of a 3D image is fixed, while in the case of elastic image fusion, the relative positions are allowed to change.

In this application, the term “image morphing” is also used as an alternative to the term “elastic image fusion”, but with the same meaning.

Elastic fusion transformations (for example, elastic image fusion transformations) are for example designed to enable a seamless transition from one dataset (for example a first dataset such as for example a first image) to another dataset (for example a second dataset such as for example a second image). The transformation is for example designed such that one of the first and second datasets (images) is deformed, for example in such a way that corresponding structures (for example, corresponding image elements) are arranged at the same position as in the other of the first and second images. The deformed (transformed) image which is transformed from one of the first and second images is for example as similar as possible to the other of the first and second images. Preferably, (numerical) optimisation algorithms are applied in order to find the transformation which results in an optimum degree of similarity. The degree of similarity is preferably measured by way of a measure of similarity (also referred to in the following as a “similarity measure”). The parameters of the optimisation algorithm are for example vectors of a deformation field. These vectors are determined by the optimisation algorithm in such a way as to result in an optimum degree of similarity. Thus, the optimum degree of similarity represents a condition, for example a constraint, for the optimisation algorithm. The bases of the vectors lie for example at voxel positions of one of the first and second images which is to be transformed, and the tips of the vectors lie at the corresponding voxel positions in the transformed image. A plurality of these vectors are preferably provided, for instance more than twenty or a hundred or a thousand or ten thousand, etc. Preferably, there are (other) constraints on the transformation (deformation), for example in order to avoid pathological deformations (for instance, all the voxels being shifted to the same position by the transformation). These constraints include for example the constraint that the transformation is regular, which for example means that a Jacobian determinant calculated from a matrix of the deformation field (for example, the vector field) is larger than zero, and also the constraint that the transformed (deformed) image is not self-intersecting and for example that the transformed (deformed) image does not comprise faults and/or ruptures. The constraints include for example the constraint that if a regular grid is transformed simultaneously with the image and in a corresponding manner, the grid is not allowed to interfold at any of its locations. The optimising problem is for example solved iteratively, for example by means of an optimisation algorithm which is for example a first-order optimisation algorithm, for example a gradient descent algorithm. Other examples of optimisation algorithms include optimisation algorithms which do not use derivations, such as the downhill simplex algorithm, or algorithms which use higher-order derivatives such as Newton-like algorithms. The optimisation algorithm preferably performs a local optimisation. If there are a plurality of local optima, global algorithms such as simulated annealing or generic algorithms can be used. In the case of linear optimisation problems, the simplex method can for instance be used.

In the steps of the optimisation algorithms, the voxels are for example shifted by a magnitude in a direction such that the degree of similarity is increased. This magnitude is preferably less than a predefined limit, for instance less than one tenth or one hundredth or one thousandth of the diameter of the image, and for example about equal to or less than the distance between neighbouring voxels. Large deformations can be implemented, for example due to a high number of (iteration) steps.

The determined elastic fusion transformation can for example be used to determine a degree of similarity (or similarity measure, see above) between the first and second datasets (first and second images). To this end, the deviation between the elastic fusion transformation and an identity transformation is determined. The degree of deviation can for instance be calculated by determining the difference between the determinant of the elastic fusion transformation and the identity transformation. The higher the deviation, the lower the similarity, hence the degree of deviation can be used to determine a measure of similarity.

A measure of similarity can for example be determined on the basis of a determined correlation between the first and second datasets.

### DESCRIPTION OF THE FIGURES

In the following, the invention is described with reference to the enclosed figures which represent a specific embodiment of the invention. The scope of the invention is not however limited to the specific features disclosed in the context of the figures, wherein

FIG. 1 illustrates a flow diagram of steps of the method in accordance with an aspect of the invention; and

FIG. 2 illustrates the properties of a growth cone.

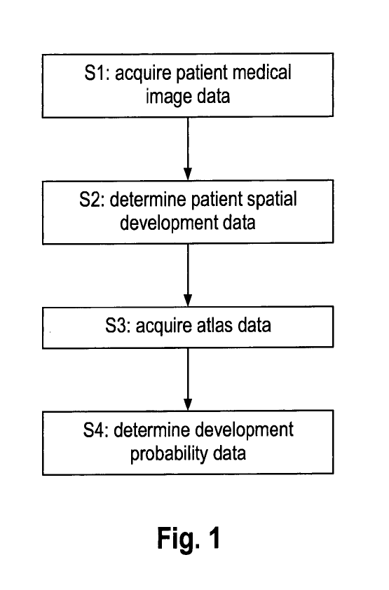

According to FIG. 1, the method starts ins step S1 with acquisition of the patient medical image data which encompasses acquiring image data describing series of scans from multiple patients, that have been taken for the purpose of tumour monitoring/tracking (the tumour has been segmented). Subsequent step S2 is directed to determining the patient spatial development data which encompasses performing image fusions for all scans in the series of one patient. In the following step S3, the atlas data comprising a description of a universal atlas is acquired. Then, for example one registration of a four-dimensional tumour monitoring series per patient to the universal atlas is performed. In subsequent step S4, the four-dimensional series of tumour objects per patient is transformed into the reference system (coordinate space) in which spatial relationships of the universal atlas are defined. Step S4 also encompasses determination of the development probability data, specifically calculation of all probable growth cones for all obtained starting configurations of tumour positions and sizes.

The resulting four-dimensional growth cone map may be saved on a non-transitory electronic (digital) computer-readable storage medium. When a new patient is treated, that patient's scan can be registered with the saved four-dimensional growth cone map. Onto that patient's anatomy, the information obtained on the basis of the four-dimensional growth cone visualization for that patient can be overlaid. The resulting information can be used during image-guided surgery, e.g. with the Navigated Brush offered by Brainlab AG or another application (e.g. in microscope head-up display) visualizing (statistical) information on the tumour in question on the patients anatomy or in the surgical situation.

Using the universal atlas as input data allows to bring information from multiple patients with differing tumour locations into one common frame of reference. Through this image, time series with segmented tumours are brought into overlay and clusters of spatially similar tumours can be identified. Such an averaging map focuses on one disease indication (such as e.g. Low-grade gliomas) and clusters the data into spatially similar tumour location groups. Once one group is identified (e.g. frontal left LGGs) the typical growth pattern can be averaged by calculating the 4D tumour growth cones and averaging them.

The universal atlas-based technology offers a method to bring four-dimensional information on tumour growth patterns into a format, from which it can be applied to individual patients and be utilized during image guided surgery. This allows real-time utilization of statistical information and clinical decision support for the surgeon in a systematic and unprecedented manner.

By now visualizing this information during surgery via Navigated Brush, the surgeon can be precisely informed on what part of the tumour on which he/she should focus on most for to be removed during surgery. Real-time removal tracking of the tumour is allowed for by the Navigated Brush by offering a possibility of intraoperative modification of a pre-planned tumour object after tumour resection. This modification is calculated by an algorithm that interpolates points that have been acquired on the surgical margin of the residual tumour using a navigated instrument. Hence, the tumour growth cone might change based on information on the growth/recurrence patterns of such residual tumours.

Advanced visualization via Navigated Brush may provide:
a coloured map indicating areas of potential tumour growth as texture on a three-dimensional tumour object;
three-dimensional simulation of potential tumour growth (rendering of a three-dimensional model);
“guided mode” visualization/workflow as real-time clinical decision support (e.g. surgeon decides/wants to be guided to only focus on areas with high potential for tumour growth);
utilization of a stereoscopic head-up display or three-dimensional video-overlay in a next-generation surgical microscope; and
volumetric report of different tumour growth areas (high, mid, low).

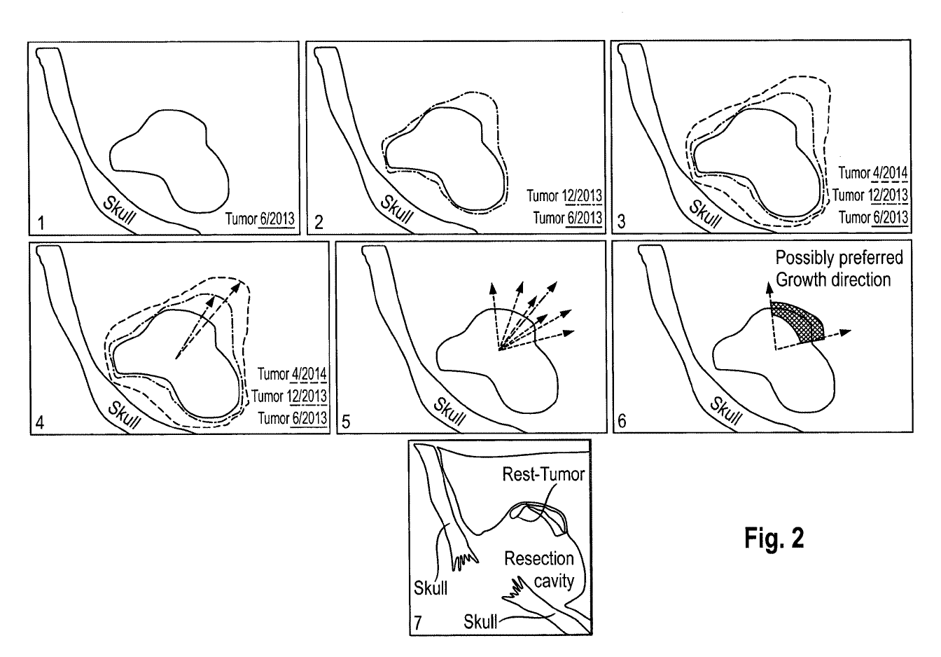

FIG. 2 shows determination of a growth cone for a specific case of tumour growth, wherein the following is illustrated in the sub-figures of FIG. 2:
Sub-figure 1: The tumour is segmented in an image.
Sub-figure 2: Follow-up scans show the growth from time point 1 to 2.
Sub-figure 3: Follow-up scans show the growth from time point 1 to 2, 2 to 3.
Sub-figure 4: Dominant growth directions can be derived from the preceding three steps.
Sub-figure 5: By using the universal atlas, multiple patient tumour growth information can be included, thereby averaging dominant growth directions from multiple patient image time series to be aggregated in one common frame of reference.
Sub-figure 6: From this averaging, information zones of the tumour at time point 1 can be highlighted which will most likely grow out most aggressively.
Sub-figure 7: During image guided surgery, the information made available in sub-figures 5 and 6 can be brought into the space of the individual patient image through registration of the patient image to the common frame of reference (sub-figure 5), now the tumour at hand can be enriched by highlighting zones with growth prediction information—this information can be visualized both on a medical navigation system (which is suitable for us e.g. in surgery) via e.g. Navigated Brush as well as in a surgical microscope with a head-up display or video-overlay configuration.

1-15. (canceled)

16. A method for determining the spatial development of tumor tissue, executed. by one or more processors, comprising:
acquiring, by one or more of the processors, patient medical image data describing sequences of patient medical images of tumors in parts of patient bodies, wherein the patient medical images of each sequence have been taken at subsequent points in time and each sequence has been taken for a different patient;
determining, by one or more of the processors, by additively fusing subsequent patient medical images of each sequence to one another, patient spatial development data describing the spatial development of a tumor in each patient body;
acquiring, by one or more of the processors, atlas data describing an atlas representation of the parts of patient bodies;
determining, by one or more of the processors, based on the atlas data and the patient development data, development probability data describing a probability for a spatial development of a tumor.

17. The method according to claim 16, wherein the development probability data is determined, by one or more of the processors, based on transforming the patient spatial development data into an atlas reference system in which spatial relationships in the atlas representation are defined.

18. The method according to claim 17, wherein transforming the patient spatial development data into the atlas reference system includes fusing, by one or more of the processors and to the atlas data, the result of additively fusing the patient medical images of each sequence.

19. The method according to claim 16, wherein the position of the tumor in the first patient medical image of each sequence is used as a starting condition for determining the development probability data.

20. The method according to claim 19, wherein determining the development probability data includes determining a growth cone of the tumor for each starting condition, the growth cone describing a probability of a spatial development of the tumor relative to a specific main development direction

21. The method according to claim 16, comprising:
acquiring, by one or more of the processors, patient-specific medical image data describing a tumor in a patient to be treated;
determining, by one or more of the processors, based on the patient-specific medical image data and the development probability data, patient-specific development probability data describing a probability for a spatial development of the tumor in the patient to be treated.

22. The method according to claim 21, wherein the patient-specific development probability data is determined by one or more of the processors by registering the patient-specific medical image data with the development probability data.

23. The method according to claim 21, comprising:
determining, by one or more of the processors and based on the patient-specific medical image data and the patient-specific development probability data, patient-specific probability indication data describing an indication signal to be output to a user using the information content of the patient-specific development probability data.

24. The method according to claim 23, comprising:
outputting, to a user and using an indication device for indicating digital information, the indication signal.

25. The method according to claim 24, wherein the indication device includes a graphical output device and wherein the indication to be output includes a visualization of the information content of the patient-specific probability indication data.

26. The method according to claim 21, Wherein the patient medical image data has been taken by application of a computed x-ray tomography imaging method or a magnetic resonance imaging method to the patients' bodies, or by imaging of radiation emitted from a substance emitting ionizing radiation introduced into the patients' bodies.

27. The method according to claim 21, wherein a colored map is determined based on the development probability data, wherein the colored map indicates areas of potential tumor growth and is overlaid as texture on a three-dimensional tumor object.

28. The method according to claim 27, wherein the colored map is displayed on at least one of a display device of a surgical microscope and a medical head-up display.

29. At least one non-transitory storage medium storing instructions for determining the spatial development of tumor tissue, the instructions comprising:
a plurality of instructions which, when executed by one or more processors, causes the one or more processors to:
acquire, by one or more of the processors, patient medical image data describing sequences of patient medical images of tumors in parts of patient bodies, wherein the patient medical images of each sequence have been taken at subsequent points in time and each sequence has been taken for a different patient;
determine, by one or more of the processors, by additively fusing subsequent patient medical images of each sequence to one another, patient spatial development data describing the spatial development of a tumor in each patient body;
acquire, by one or more of the processors, atlas data describing an atlas representation of the parts of patient bodies;
determine, by one or more of the processors, based on the atlas data and the patient development data, development probability data describing a probability for a spatial development of a tumor.

30. A system for determining the spatial development of tumor tissue, comprising:
memory storing instructions to cause one or more processors to:
acquire, by one or more of the processors, patient medical image data describing sequences of patient medical images of tumors in parts of patient bodies, wherein the patient medical images of each sequence have been taken at subsequent points in time and each sequence has been taken for a different patient;
determine, by one or more of the processors, by additively fusing subsequent patient medical images of each sequence to one another, patient spatial development data describing the spatial development of a tumor in each patient body;
acquire, by one or more of the processors, atlas data describing an atlas representation of the parts of patient bodies;
determine, by one or more of the processors, based on the atlas data and the patient development data, development probability data describing a probability for a spatial development of a tumor;
a display device operatively coupled to one or more of the processors for displaying information content of data determined by one or more of the processors.
